(19) United States
(12) Patent Application Publication
(10) Pub. No.: US 2007/0237333 A1
(43) Pub. Date: Oct. 11, 2007

(54) FM transmitter using switched capacitor filter

(76) Inventor: Takeshi Sagara, Ukyo-Ku (JP)

Correspondence Address: CANTOR COLBURN, LLP, 55 GRIFFIN ROAD SOUTH, BLOOMFIELD, CT, 06002, US

(21) Appl. No.: 11/786,196

(22) Filed: Apr. 11, 2007

(30) Foreign Application Priority Data
Apr. 11, 2006 (JP) JP2006-108322

(51) Int. Cl. H04H 5/00

(52) U.S. Cl. 381/7; 381/3

(57) ABSTRACT

The FM transmitter converts an input audio signal to a stereo composite signal, frequency-modulates the stereo composite signal and outputs the obtained signal. A stereo modulator stereo-modulates the output signal of the filter circuit, and converts the signal to the stereo composite signal. A frequency modulator frequency-modulates based on the stereo composite signal output from the stereo modulator. The filter circuit includes a pre-emphasis circuit, a low pass filter and the like, for example. At least one part of the filter circuit, that is, the low pass filter or the pre-emphasis circuit is configured with a switched capacitor filter.

### BACKGROUND OF THE INVENTION

1. Field of the Invention

The present invention relates to an FM transmitter for generating a stereo composite signal, frequency-modulating the stereo composite signal and outputting the obtained signal.

2. Description of the Related Art

An FM transmitter for converting an audio signal to a stereo composite signal, frequency-modulating the stereo composite signal using a frequency modulator and outputting the obtained signal is known. Such FM transmitter is able to transmit the audio signal without using wirings such as RCA cable, and thus is used in transmitting signals between the CD changer of a car audio and the main head unit. Furthermore, hard disc audio equipments, memory audio equipments, portable telephone terminals having music reproducing function are significantly becoming widely used in recent years, and FM transmitter is used to reproduce musical data stored in such compact electronic equipments from a speaker of a stationary audio component stereo and the like. Japanese Patent Application Laid-open Nos. H9-069729, H10-013370 and H9-312588 disclose related frequency modulators and FM transmitters.

Miniaturization of the circuit is a critical issue when incorporating the FM transmitter in the compact electronic equipments such as a portable telephone terminal. In the FM transmitter, a filter circuit including a pre-emphasis circuit for emphasizing the high pass frequency component of the audio signal, a low pass filter for removing the high pass component are arranged at the pre-stage of the frequency modulator (see Japanese Patent Application Laid-open No. H9-312588).

[Patent document 1] Japanese Patent Application Laid-open No. H9-069729

[Patent document 2] Japanese Patent Application Laid-open No. H10-013370

[Patent document 3] Japanese Patent Application Laid-open No. H9-312588

When the filter circuit is configured as an analog filter using resistor element and capacitor element, the frequency characteristic of the filter tends to fluctuate due to variability in resistance value and capacitance value of the elements. Furthermore, the capacitance value of the capacitor becomes extremely large as the frequency band of the audio signal is being handled, and thus it becomes difficult to be incorporated in an IC (Integrated Circuit), which increases the number of components. The increase in the number of components also inhibits mounting to the compact electronic equipment.

### SUMMARY OF THE INVENTION

The present invention is made in view of the above problems, a general purpose of the present invention is to provide an FM transmitter in which the circuit size is reduced.

One embodiment of the present invention relates to an FM transmitter for converting an input audio signal to a stereo composite signal, and frequency-modulating the stereo composite signal and outputting the obtained signal. The FM transmitter includes a filter circuit to which the input audio signal is input, and which corrects the band and outputs the band-corrected signal; a stereo modulator which stereo-modulates the output signal of the filter circuit, and converts the signal to the stereo composite signal; and a frequency modulator which frequency-modulates based on the stereo composite signal output from the stereo modulator. At least one part of the filter circuit is configured with a switched capacitor filter.

According to such embodiment, the capacitance value for determining the band of the filter is made small since the filter circuit is configured with the switched capacitor filter, whereby integration on the semiconductor substrate becomes possible, and the circuit can be simplified.

The filter circuit may include a low pass filter which removes high frequency component of the input audio signal, the low pass filter may be configured with the switched capacitor filter. In another embodiment, the filter circuit may include a pre-emphasis circuit which emphasizes the high frequency component of the input audio signal, the pre-emphasis circuit may be configured with the switched capacitor filter. In still another embodiment, both the low pass filter and the pre-emphasis circuit may be configured with the switched capacitor filter.

When the low pass filter is configured with the switched capacitor filter, the frequency characteristic can be flexibly designed, and the filter of high order, for example, about third order to seventh order can be configured using a few or a several dozen capacitors of a few pF to a several dozen pF. Furthermore, such capacitor can be integrated on the semiconductor substrate, thereby reducing the number of components. When the pre-emphasis circuit is configured with the switched capacitor filter, the circuit can be simplified by integrating the capacitor, the fluctuation of the frequency characteristic caused by variability in the resistance value and the capacitance value of the circuit components can be reduced compared to when external components are used, and a stable pre-emphasis function can be realized. If both the low pass filter and the pre-emphasis circuit are configured with the switched capacitor filter, the circuit can be further simplified, and the frequency correction with respect to the input audio signal is stabilized.

The frequency characteristic of the low pass filter configured with the switched capacitor filter may have a notch at 19 kHz and 38 kHz. Excellent frequency-modulated wave is generated by removing the frequency component of the sub-carrier wave of the stereo modulator and the frequency component of the pilot signal from the audio signal.

The order of the low pass filter configured with the switched capacitor filter may be fifth order, and the frequency characteristic thereof may have a notch at 19 kHz and 38 kHz. In this case, the balance between the circuit area and the performance of the FM transmitter is suitably set.

The pre-emphasis circuit configured with the switched capacitor filter may include a variable capacitor, and the frequency to be emphasized (hereinafter referred to as pre-emphasis time constant) may be varied depending on the capacitance value of the variable capacitor. In this case, the pre-emphasis circuit can be used in a plurality of countries and regions having different pre-emphasis time constant by changing the capacitance value.

The frequency of a clock signal used for switching the switched capacitor filter may be between 100 kHz and 1 MHz. The capacitance value of the capacitor can be set to a range suitable for integration by using the clock signal of the relevant band.

The frequency modulator is configured with a direct modulation type including a PLL (Phase Locked Loop); and a clock signal used for switching the switched capacitor filter may be a signal having the same origin as a reference clock signal of the PLL circuit of the frequency modulator. The clock signal used for switching the switched capacitor filter may be a signal having the same origin as the sub-carrier wave of 38 kHz and the pilot signal of 19 kHz used in the stereo modulator.

The clock signal can be indirectly or directly shared with other signals, whereby a dedicated oscillator becomes unnecessary, and the circuit can be simplified.

The FM transmitter of another embodiment may further include a frequency divider which frequency-divides a system clock of a set mounted with the FM transmitter, and outputs the obtained signal as a clock signal used for switching the switched capacitor filter.

The stereo modulator, the frequency modulator and one part of the filter circuit configured with the switched capacitor filter may be integrated on one semiconductor substrate. “integrated” includes a case of forming all the components of the circuit on the semiconductor substrate or a case of integrally integrating the main components of the circuit, and one part of the resistor or the capacitor may be arranged exterior in order to the semiconductor substrate to adjust the circuit constant. The circuit area can be saved by integrating the circuits on one LSI.

Another embodiment of the present invention relates to a filter circuit arranged at a pre-stage of a frequency modulator which frequency-modulates an input audio signal. The filter circuit includes a pre-emphasis circuit which emphasizes high frequency component of the input audio signal; and a low pass filter which is arranged at a pre-stage or a post-stage of the pre-emphasis circuit, and removes the high frequency component of the input audio signal. At least one of the pre-emphasis circuit or the low pass filter is configured with a switched capacitor filter.

The frequency modulator may be configured with a direct modulation type including a PLL (Phase Locked Loop) circuit, and a clock signal used for switching the switched capacitor filter may be a signal having the same origin as a reference clock signal of the PLL circuit of the frequency modulator.

Another further embodiment of the present invention relates to a compact electronic equipment. The compact electronic component includes the FM transmitter described above; an antenna which transmits an output signal of the FM transmitter to the outside; an oscillator which generates a system clock of a predetermined frequency; and a first frequency divider which frequency-divides the system clock at a first frequency dividing ratio, and supplies the obtained signal to the switched capacitor filter of the FM transmitter. The compact electronic equipment may further include a second frequency divider which frequency-divides the system clock at a second frequency dividing ratio and supplies the obtained signal to a stereo modulator of the FM transmitter in order to generate a sub-carrier wave of 38 kHz and a pilot signal of 19 kHz; and a third frequency divider which frequency-divides the system clock at a third frequency dividing ratio, and supplies the obtained signal to the frequency modulator of the FM transmitter configured with a direct modulation type including a PLL (Phase Locked Loop) circuit as a reference clock signal of the PLL circuit.

According to such embodiment, the compact electronic equipment can be miniaturized by mounting the FM transmitter using the switched capacitor filter. The device can be simplified and reduced in cost since one system clock is shared by arranging first to third frequency dividers.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing a configuration of an FM transmitter according to an embodiment of the present invention;

FIG. 2 is a block diagram showing a configuration of a filter circuit of FIG. 1;

FIG. 3 is a circuit diagram showing a configuration example of the pre-emphasis circuit of FIG. 2;

FIG. 4 is a circuit diagram showing a configuration example of when the third capacitor of FIG. 3 is a variable capacitor;

FIG. 5 is a circuit diagram showing a configuration example of the low pass filter of FIG. 2;

FIG. 6 is a view showing the frequency characteristic of the low pass filter of FIG. 5;

FIG. 7 is a block diagram showing the internal configuration of the stereo modulator and the frequency modulator of the FM transmitter of FIG. 1; and

FIG. 8 is a block diagram showing a configuration of a compact electronic equipment mounted with the FM transmitter according to the embodiment.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

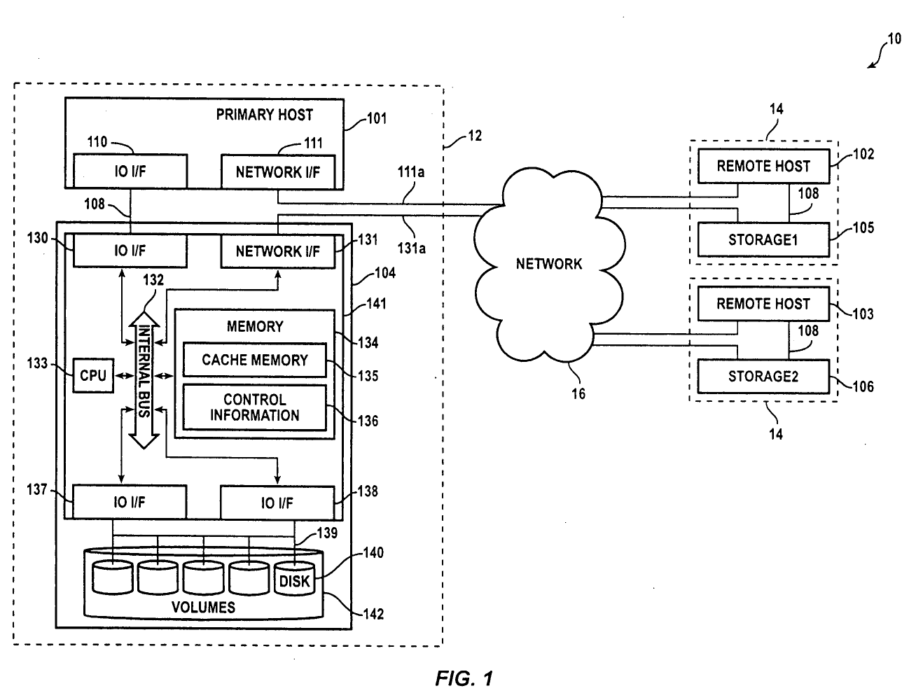

FIG. 1 is a circuit diagram showing a configuration of an FM transmitter 100 according to the embodiment of the present invention. In the subsequent figures, the same reference numerals are denoted for components which are same or equivalent to the already mentioned components, and the appropriate description thereof is not repeated. The FM transmitter 100 converts a stereo audio signal S1L, S1R (hereinafter referred to simply as input audio signal S1) including L channel and R channel input to an input terminal 102 to a stereo composite signal, frequency-modulates, and thereafter, amplifies the stereo composite signal and outputs the obtained signal from an output terminal 104. The FM transmitter 100 may be integrally integrated as a function of IC on one semiconductor substrate. The audio signal input to the input terminal 102 may be monoaural.

The configuration of the FM transmitter 100 and the outline of signal processing will be described first. The FM transmitter 100 includes a filter circuit 50, a stereo modulator 10, a frequency modulator 20, a power amplifier 30, a first programmable frequency divider 40, a second programmable frequency divider 42, and a third programmable frequency divider 44. The input audio signal S1 is input to the filter circuit 50. The filter circuit 50 corrects the band of the input audio signal S1 and outputs the band-corrected signal. The stereo modulator 10 stereo-modulates the band-corrected audio signals S1L′, S1R′, which is the output signal of the filter circuit 50, and converts the band-corrected audio signal to a stereo composite signal S2. The frequency modulator 20 frequency-modulates based on the stereo composite signal S2 output from the stereo modulator 10. The frequency modulator 20 outputs a high frequency signal S3 having carrier frequency to the power amplifier 30. The power amplifier 30 amplifies the input high frequency signal S3, and outputs the amplified high frequency signal S4 from the output terminal 104.

The present embodiment is characterized in that at least one part of the filter circuit 50 is configured with a switched capacitor filter. The filter circuit 50 is configured by including a pre-emphasis circuit for emphasizing the high frequency component of the input audio signal S1, a low pass filter for removing the high frequency component of the input audio signal S1, as described in detail below.

The capacitance value of the capacitors for determining the band of the filter is made small by configuring one part of the filter circuit 50 with the switched capacitor filter, whereby integration on the semiconductor substrate becomes possible, and the circuit can be simplified.

In the present embodiment, a first clock signal CK1 used for switching of the switched capacitor filter of the filter circuit 50 is preferably set between 100 kHz and 1 MHz. If the frequency of the first clock signal CK1 is set in such range, the capacitance value of the capacitor configuring the switched capacitor filter can be made to about a few pF, thereby facilitating the integration on the IC. Furthermore, if the frequency of the first clock signal CK1 is made to higher than or equal to 100 kHz, the frequency becomes by a several times higher than the sub-carrier wave of 38 kHz and a pilot signal of 19 kHz used in the stereo modulator 10 of the post-stage, and thus the influence of the first clock signal CK1 on the stereo modulation is reduced, and stable stereo modulation is realized.

In the present embodiment, the first clock signal CK1 used for switching of the switched capacitor filter of the filter circuit 50 has the same origin as the sub-carrier wave of 38 kHz and the pilot signal of 19 kHz used in the stereo modulator 10. Moreover, in the present embodiment, the frequency modulator 20 is configured with a direct modulation type using a PLL circuit, and the first clock signal CK1 has the same origin as a reference clock signal of the PLL circuit of the frequency modulator 20.

The technique of sharing the clock signal with the filter circuit 50, the stereo modulator 10 and the frequency modulator 20 will now be described. An external clock signal CKext is input to the clock input terminal 106. The conditions of the frequency of the external clock signal CKext is desirably determined in advance as the specification of the FM transmitter 10. For example, the frequency of the external clock signal CKext is assumed to be input as one of the frequencies marked for every predetermined frequency width Δf between 10 MHz to 20 MHz in the FM transmitter 100 of an embodiment.

The first programmable frequency divider 40 frequency-divides the external clock signal CKext input from the outside at a first frequency dividing ratio n1 set in advance, and outputs the obtained signal to the filter circuit 50 as the first clock signal CK1. The frequency f1 of the first clock signal CK1 input to the filter circuit 50 is given as f1=fext/n1 using the frequency fext of the external clock signal CKext. The first clock signal CK1 is used for switching the switched capacitor filter in the filter circuit 50.

The second programmable frequency divider 42 frequency-divides the external clock signal CKext input from the outside at a second frequency dividing ratio n2 set in advance, and outputs the obtained signal to the stereo modulator 10. That is, the frequency f2 of the second clock signal CK2 input to the stereo modulator 10 is given as f2=fext/n2 using the frequency fext of the external clock signal CKext. The second clock signal CK2 output from the second programmable frequency divider 42 is used as a reference clock signal for generating the stereo composite signal S2 in the stereo modulator 10. The second frequency dividing ratio n2 is set so that the frequency f2 of the second clock signal CK2 becomes a value closest to 38 kHz in the present embodiment.

The third programmable frequency divider 44 frequency-divides the external clock signal CKext at a third frequency dividing ratio n3 set in advance, and outputs the obtained signal to the frequency modulator 20. The frequency f3 of the third clock signal CK3 input to the frequency modulator 20 is given as f3=fext/n3 using the frequency fext of the external clock signal CKext. The frequency modulator 20 is configured with a direct modulation type including the PLL circuit, as hereinafter described. The third clock signal CK3 output from the third programmable frequency divider 44 is used as a reference clock signal of the PLL circuit of the frequency modulator 20.

Therefore, the clock signals used in the filter circuit 50, the stereo modulator 10, and the frequency modulator 20 can be indirectly shared by arranging three frequency dividers. An oscillator dedicated to the switched capacitor filter of the filter circuit 50 thus is not required to be arranged, thereby simplifying the circuit.

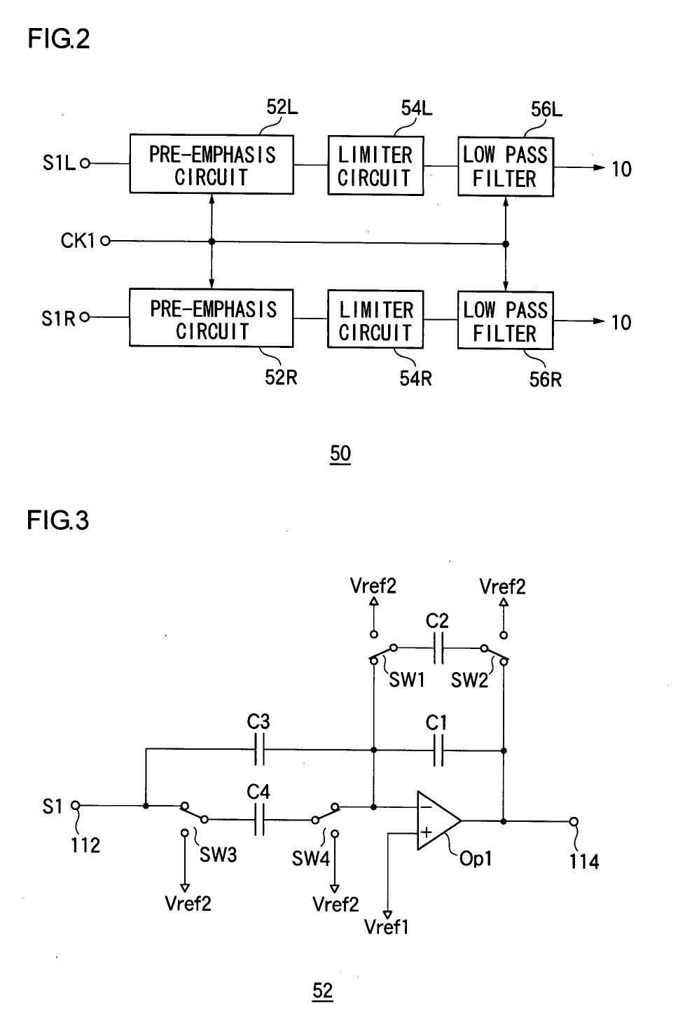

The configuration and the operation of each circuit block will now be described. FIG. 2 is a block diagram showing the configuration example of the filter circuit 50 of FIG. 1. The filter circuit 50 includes a pre-emphasis circuit 52, a limiter circuit 54, and a low pass filter 56 for each of the L channel and the R channel. The L channel and the R channel are distinguished by characters L, R attached to the reference numerals. Since the configurations of the L channel and the R channel are the same, the L channel will be described below by way of example.

The audio signal S1L, which is the L channel component of the input audio signal S1, is input to the pre-emphasis circuit 52L. The pre-emphasis circuit 52L emphasizes the high frequency component of the audio signal S1L. The limiter circuit 54L limits the level of the output signal of the pre-emphasis circuit 52L so as not to exceed a certain value. The low pass filter 56L removes the high frequency component of the output signal of the limiter circuit 54L.

In the present embodiment, the pre-emphasis circuit 52L and the low pass filter 56L are configured as switched capacitor filters. The first clock signal CK1 is input to the pre-emphasis circuit 52L and the low pass filter 56L for switching the switched capacitor filter.

The configuration of the filter circuit 50 is not limited to that in FIG. 2, and the order or the like of each block may be appropriately changed. Both the pre-emphasis circuit 52 and the low pass filter 56 is not necessarily required to be configured with the switched capacitor filter, and only one of them may be configured with the switched capacitor filter and the other may be configured as active filter or passive filter. An anti-aliasing filter may be separately arranged at the pre-stage of the pre-emphasis circuit 52 or the post-stage of the low pass filter 56.

FIG. 3 is a circuit diagram showing a configuration example of the pre-emphasis circuit 52. The pre-emphasis circuit 52 includes first capacitor C1 to fourth capacitor C4, first switch SW1 to fourth switch SW4, and a first operational amplifier Op1. The first switch SW1 to fourth switch SW4 alternately repeat to be in a first state and a second state in response to a first clock signal CK1.

A first reference voltage Vref1 is input to a non-inverted input terminal of the first operational amplifier Op1. The first capacitor C1 is arranged between the output terminal and the inverted input terminal of the first operational amplifier Op1. The output terminal of the first operational amplifier Op1 becomes the output terminal 114 of the pre-emphasis circuit 52.

The first switch SW1 is connected to the first terminal of the second capacitor C2, and the second switch SW2 is connected to the second terminal of the second capacitor C2. The path formed by connecting the first switch SW1, the second capacitor C2, and the second switch SW2 in this order is arranged parallel to the first capacitor C1. The first switch SW1 turns ON to the inverted input terminal side of the first operational amplifier Op1 in the first state and turns ON to the reference voltage terminal side applied with the second reference voltage Vref2 in the second state. The second switch SW2 turns ON to the output terminal side of the first operational amplifier Op1 in the first state, and turns ON to the reference voltage terminal side applied with the second reference voltage Vref2 in the second state.

The third capacitor C3 is arranged between the input terminal 112 of the pre-emphasis circuit 52 and the inverted input terminal of the first operational amplifier Op1. The third switch SW3 is connected to the first terminal of the fourth capacitor C4, and the fourth switch SW4 is connected to the second terminal of the fourth capacitor C4. The path formed by connecting the third switch SW3, the fourth capacitor C4, and the fourth switch SW2 in this order is arranged parallel to the third capacitor C3. The third switch SW3 turns ON to the input terminal 112 side in the first state and turns ON to the reference voltage terminal side applied with the second reference voltage Vref2 in the second state. The fourth switch SW4 turns ON to the inverted input terminal side of the first operational amplifier Op1 in the first state, and turns ON to the reference voltage terminal side applied with the second reference voltage Vref2 in the second state.

The pre-emphasis circuit 52 alternately repeats to be in the first state and the second state in response to the first clock signal CK1. The state of the first switch SW1 to the fourth switch SW4 shown in FIG. 3 is the first state. The state in which each switch SW1 to SW4 is turned ON to the opposite side of that in FIG. 3 is the second state.

The frequency characteristic of the pre-emphasis circuit 52 configured as above is given as 1+ωT. Here, ω is the angular frequency of the input audio signal S1 and τ is the time constant of the pre-emphasis circuit 52.

The time constant τ of the pre-emphasis circuit 52 is defined by the frequency f1 of the first clock signal CK1 and the capacitance value of the first capacitor C1 to the fourth capacitor C4. In one example, it may be configured so that the relationships f1=500 kHz, C1=C2=C4=1 pF are satisfied. In this case, the relationship τ=0 μs is satisfied when the relationship C3=1 pF is satisfied, τ=50 μs when C3=25 pF, τ=75 μs when C3=37.5 pF, and τ=100 μs when C3=50 pF.

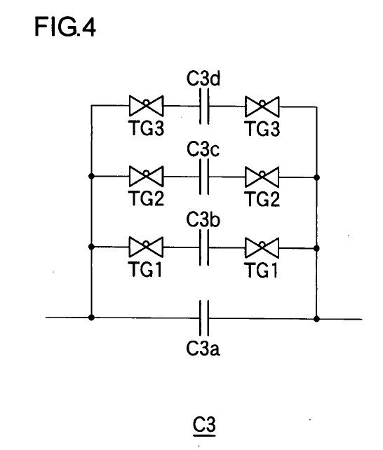

The time constant τ of the pre-emphasis circuit 52 is required to be set according to the country and the region where the FM transmitter 100 is used. The third capacitor C3 may be configured as a variable capacitor. FIG. 4 is a circuit diagram showing a configuration example of the third capacitor C3 serving as a variable capacitor. The third capacitor C3 includes four capacitors of third capacitor C3a to third capacitor C3d arranged in parallel to each other. A transfer gate TG1 is arranged at both ends of the third capacitor C3b. Similarly, transfer gates TG2, TG3 are respectively arranged at both ends of the third capacitors C3c, C3d.

When the relationships C3a=1 pF, C3b=24 pF, C3c=12.5 pF, and C3d=12.5 pF are satisfied and all the transfer gates TG1 to TG3 are turned OFF, the time constant is to be τ=0 μs. When the transfer gate TG1 is turned ON, the time constant is to be τ=50 μs; when transfer gates TG1, TG2 are turned ON, τ=75 μs; and when all the transfer gates TG1, TG2, TG3 are turned ON, τ=100 μs.

The configuration of the pre-emphasis circuit 52 of FIG. 3 is illustrative, and other configurations may be adopted. For example, the third capacitor C3 may not be a variable capacitor as shown in FIG. 4, and only the third capacitor C3 may be configured as an external component. Other configurations are possible for the circuit form as long as the desired pre-emphasis characteristic can be obtained.

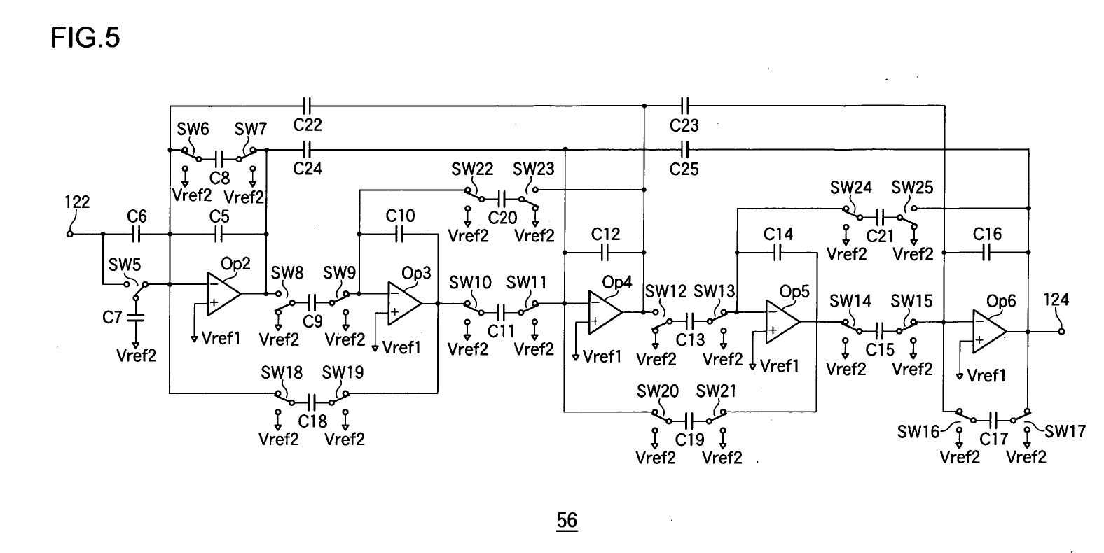

The low pass filter 56 configured with the switched capacitor filter will now be described. FIG. 5 is a circuit diagram showing a configuration example of the low pass filter 56. The low pass filter 56 is a Chebychev low pass filter of fifth order configured with the switched capacitor filter. The low pass filter 56 includes second operational amplifier Op2 to sixth operational amplifier Op6, fifth capacitor C5 to twenty sixth capacitor C26, and a plurality of switches SW5 to SW25. The plurality of switches SW5 to SW25 alternately takes the first state and the second state in response to the first clock signal CK1. FIG. 5 shows the first state, and a state in which each switch is turned ON to the opposite side is the second state.

The low pass filter 56 removes the high frequency component of the signal input to the input terminal 122, and outputs the obtained signal from the output terminal 124. The first reference voltage Vref1 is applied to the non-inverted input terminals of each of the second operational amplifier Op2 to the sixth operational amplifier Op6.

A fifth capacitor C5 is arranged between the output terminal and the non-inverted input terminal of the second operational amplifier Op2. A sixth capacitor C6 is arranged between the input terminal 122 and the inverted input terminal of the second operational amplifier Op2. The first terminal of the seventh capacitor C7 is connected to the reference voltage terminal applied with the second reference voltage Vref2, and the switch SW5 is connected to the second terminal. The switch SW5 turns ON to the inverted input terminal side of the second operational amplifier Op2 in the first state, and turns ON to the input terminal 122 side in the second state.

The switches SW6, SW7 are connected to both ends of the eighth capacitor C8. The path configured by including the eighth capacitor C8 and the switches SW6, SW7 is arranged parallel to the fifth capacitor C5. The switch SW6 turns ON to the inverted input terminal side of the second operational amplifier Op2 in the first state, and turns ON to the reference voltage terminal side applied with the second reference voltage Vref in the second state. The switch SW7 turns ON to the output terminal side of the second operational amplifier Op2 in the first state, and turns ON to the reference voltage terminal side applied with the second reference voltage Vref in the second state.

The switches SW8, SW9 are connected to both ends of the ninth capacitor C9. The path configured by including the ninth capacitor C9 and the switches SW8, SW9 is arranged between the output terminal of the second operational amplifier Op2 and the inverted input terminal of the third operational amplifier Op3. The switch SW8 turns ON to the reference voltage terminal side applied with the second reference voltage Vref2 in the first state, and turns ON to the output terminal side of the second operational amplifier Op2 in the second state. The switch SW9 turns ON to the inverted input terminal side of the third operational amplifier Op3 in the first state, and turns ON to the reference voltage terminal side applied with the second reference voltage Vref2 in the second state. The tenth capacitor C10 is arranged between the output terminal and the inverted input terminal of the third operational amplifier Op3.

The switches SW10, SW11 are connected to both ends of the eleventh capacitor C11. The path configured by including the eleventh capacitor C11 and the switches SW10, SW11 is arranged between the output terminal of the third operational amplifier Op3 and the inverted input terminal of the fourth operational amplifier Op4. The switch SW10 turns ON to the output terminal side of the third operational amplifier Op3 in the first state, and turns ON to the reference voltage terminal side applied with the second reference voltage Vref2 in the second state. The switch SW11 turns ON to the inverted input terminal side of the fourth operational amplifier Op4 in the first state, and turns ON to the reference voltage terminal side applied with the second reference voltage Vref2 in the second state. The twelfth capacitor C12 is arranged between the output terminal and the inverted input terminal of the fourth operational amplifier Op4.

The switches SW12, SW13 are connected to both ends of the thirteenth capacitor C13. The path configured by including the thirteenth capacitor C13 and the switches SW12, SW13 is arranged between the output terminal of the fourth operational amplifier Op4 and the inverted input terminal of the fifth operational amplifier Op5. The switch SW12 turns ON to the reference voltage terminal side applied with the second reference voltage Vref2 in the first state, and turns ON to the output terminal side of the fourth operational amplifier Op4 in the second state. The switch SW13 turns ON to the inverted input terminal side of the fifth operational amplifier Op4 in the first state, and turns ON to the reference voltage terminal side applied with the second reference voltage Vref2 in the second state. The fourteenth capacitor C14 is arranged between the output terminal and the inverted input terminal of the fifth operational amplifier Op5.

The switches SW14, SW15 are connected to both ends of the fifteenth capacitor C15. The path configured by including the fifteenth capacitor C15 and the switches SW14, SW15 is arranged between the output terminal of the fifth operational amplifier Op5 and the inverted input terminal of the sixth operational amplifier Op6. The switch SW14 turns ON to the output terminal side of the fifth operational amplifier Op5 in the first state, and turns ON to the reference voltage terminal side applied with the second reference voltage Vref2 in the second state. The switch SW15 turns ON to the inverted input terminal side of the sixth operational amplifier Op6 in the first state, and turns ON to the reference voltage terminal side applied with the second reference voltage Vref2 in the second state. The sixteenth capacitor C16 is arranged between the output terminal and the inverted input terminal of the sixth operational amplifier Op6.

The switches SW16, SW17 are connected to both ends of the seventeenth capacitor C17. The path configured by including the seventeenth capacitor C17 and the switches SW16, SW17 is arranged between the output terminal and the inverted input terminal of the sixth operational amplifier Op6. The switch SW16 turns ON to the inverted input terminal side of the sixth operational amplifier Op6 in the first state, and turns ON to the reference voltage terminal side applied with the second reference voltage Vref2 in the second state. The switch SW17 turns ON to the output terminal side of the sixth operational amplifier Op6 in the first state, and turns ON to the reference voltage terminal side applied with the second reference voltage Vref2 in the second state.

The switches SW18, SW19 are connected to both ends of the eighteenth capacitor C18. The path configured by including the eighteenth capacitor C18 and the switches SW18, SW19 is arranged between the output terminal of the third operational amplifier Op3 and the inverted input terminal of the second operational amplifier Op2. The switch SW18 turns ON to the inverted input terminal side of the second operational amplifier Op2 in the first state, and turns ON to the reference voltage terminal side applied with the second reference voltage Vref2 in the second state. The switch SW19 turns ON to the output terminal side of the third operational amplifier Op3 in the first state, and turns ON to the reference voltage terminal side applied with the second reference voltage Vref2 in the second state.

The switches SW20, SW21 are connected to both ends of the nineteenth capacitor C19. The path configured by including the nineteenth capacitor C19 and the switches SW20, SW21 is arranged between the output terminal of the fifth operational amplifier Op5 and the inverted input terminal of the fourth operational amplifier Op4. The switch SW20 turns ON to the inverted input terminal side of the fourth operational amplifier Op4 in the first state, and turns ON to the reference voltage terminal side applied with the second reference voltage Vref2 in the second state. The switch SW21 turns ON to the output terminal side of the fifth operational amplifier Op5 in the first state, and turns ON to the reference voltage terminal side applied with the second reference voltage Vref2 in the second state.

The switches SW22, SW23 are connected to both ends of the twentieth capacitor C20. The path configured by including the twentieth capacitor C20 and the switches SW22, SW23 is arranged between the output terminal of the fourth operational amplifier Op4 and the inverted input terminal of the third operational amplifier Op3. The switch SW22 turns ON to the inverted input terminal side of the third operational amplifier Op3 in the first state, and turns ON to the reference voltage terminal side applied with the second reference voltage Vref2 in the second state. The switch SW23 turns ON to the reference voltage terminal side applied with the second reference voltage Vref2 in the first state and turns ON to the output terminal side of the fourth operational amplifier Op4 in the second state.

The switches SW24, SW25 are connected to both ends of the twenty-first capacitor C21. The path configured by including the twenty-first capacitor C21 and the switches SW24, SW25 is arranged between the output terminal of the sixth operational amplifier Op6 and the inverted input terminal of the fifth operational amplifier Op5. The switch SW24 turns ON to the inverted input terminal side of the fifth operational amplifier Op5 in the first state, and turns ON to the reference voltage terminal side applied with the second reference voltage Vref2 in the second state. The switch SW25 turns ON to the reference voltage terminal side applied with the second reference voltage Vref2 in the first state and turns ON to the output terminal side of the sixth operational amplifier Op6 in the second state.

The twenty-second capacitor C22 is arranged between the output terminal of the fourth operational amplifier Op4 and the inverted input terminal of the second operational amplifier Op2. The twenty-third capacitor C23 is arranged between the inverted input terminal of the sixth operational amplifier Op6 and the output terminal of the fourth operational amplifier Op4. The twenty-fourth capacitor C24 is arranged between the inverted input terminal of the fourth operational amplifier Op4 and the output terminal of the second operational amplifier Op2. The twenty-fifth capacitor C25 is arranged between the output terminal of the sixth operational amplifier Op6 and the inverted input terminal of the fourth operational amplifier Op4.

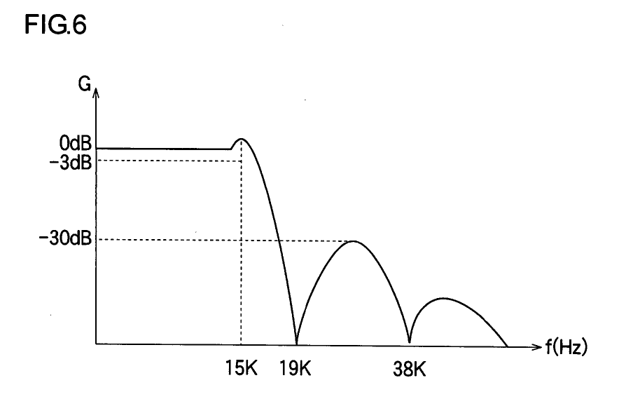

The frequency characteristic of the low pass filter 56 is preferably designed so as to have notches at 19 kHz and 38 kHz. This is realized when the frequency of the first clock signal CK1 to be f1=500 kHz, and the relationships C5=32 pF, C6=2 pF, C7=8 pF, C8=4 pF, C9=2 pF, C10=16 pF, C11=4 pF, C12=32 pF, C13=2 pF, C14=16 pF, C15=4 pF, C16=11 pF, C17=4 pF, C18=4 pF, C19=4 pF, C20=2 pF, C21=2 pF, C22=16 pF, C23=2.2 pF, C24=8.8 pF, C25=3 pF are satisfied. FIG. 6 shows the frequency characteristic of the low pass filter 56 of FIG. 5. In the present embodiment, a satisfactory filter, which has flat transmission characteristics up to 15 kHz and which rapidly attenuates at 19 kHz, can be configured since the Chebychev filter of fifth order is configured. When configuring such filter with analog active filter, an extremely large capacitor of a several dozen nF is required, and thus makes integration difficult. The capacitor can be integrated on the semiconductor substrate by using the switched capacitor filter as in the present embodiment.

Furthermore, when the notches are formed at 19 kHz and 38 kHz, as shown in FIG. 6, the interference of the sub-carrier wave of 38 kHz and the pilot signal of 19 kHz is suppressed in the stereo modulator 10 of post-stage, whereby satisfactory stereo modulation can be realized.

The configuration and the frequency characteristic of the low pass filter 56 are obviously not limited to those of FIGS. 5 and 6. In other words, the low pass filter 56 may be designed so that the characteristic necessary in the FM transmitter 100 as a whole is obtained, but the order of the filter is preferably of third order to seventh order. If a filter of about second order is adequate, the filter is configured as analog filter instead of as the switched capacitor filter.

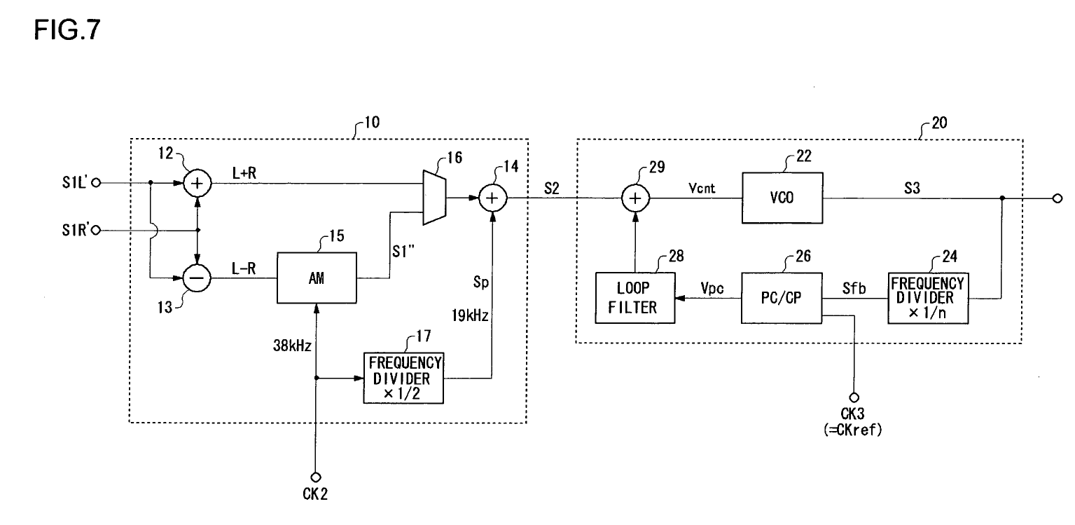

FIG. 7 is a block diagram showing the internal configuration of the stereo modulator 10 and the frequency modulator 20 of the FM transmitter 100 of FIG. 1. Since the configurations and the operations of the stereo modulator 10 and the frequency modulator 20 are widely known, they will be described briefly here.

The stereo modulator 10 includes an adder 12, a subtracter 13, an adder 14, an amplitude modulator 15, a multiplexer 16, and a ½ frequency divider 17. The adder 12 adds the stereo audio signals S1L′ and S1R′ of L channel and R channel, and generates a sum signal L+R. The subtracter 13 generates a differential signal L−R from the stereo audio signals S1L′ and S1R′ of L channel and R channel. The amplitude modulator 15 amplitude-modulates a second clock signal CK2 of 38 kHz output from the second programmable frequency divider 42 of FIG. 1 using the differential signal L−R. The multiplexer 16 combines the sum signal L+R and the sub-carrier wave S1″ output from the amplitude modulator 15. The ½ frequency divider 17 frequency-divides the second clock signal CK2 of 38 kHz to ½, and generates a pilot signal Sp of 19 kHz. The adder 14 combines the output signal of the multiplexer 16 and the pilot signal Sp, and generates a stereo composite signal S2.

The frequency modulator 20 includes a VCO 22, a frequency divider 24, a phase comparator 26, a loop filter 28, and an adder 29. The VCO 22 oscillates at the frequency corresponding to a control voltage Vcnt. The output signal S3 of the VCO 22 is output to the outside as signal to be modulated, and is also input to the frequency divider 24. The frequency divider 24 frequency-divides the frequency frf of the output signal S3 of the VCO 22 to 1/n (n is a natural number), and outputs a feedback signal Sfb. The phase comparator 26 compares the feedback signal Sfb having the frequency frf/n output from the frequency divider 24 with the reference clock signal CKref, and outputs a voltage (hereinafter referred to as phase differential voltage Vpc) corresponding to the phase difference of the two signals. The reference clock signal CKref of the PLL circuit is the third clock signal CK3 output from the third programmable frequency divider 44 of FIG. 1, as described above.

The loop filter 28 removes the high frequency component of the phase difference voltage Vpc output from the phase comparator 26, and outputs the result to the adder 29. The adder 29 superimposes the stereo composite signal S2 output from the stereo modulator 10 on the output signal of the loop filter 28, and outputs the obtained signal as the control voltage Vcnt.

The output signal S3 of the VCO 22 is a signal having a carrier frequency frf=CK2×n, and frequency-modulated by the stereo composite signal S2. The frequency of the reference clock signal CKref(=CK3) of the PLL circuit is set to a value by which the frequency necessary as the signal to be modulated S3 output from the frequency modulator 20 is obtained. That is, when the frequency of the wave to be carried is changed at steps of 100 kHz, the frequency of the reference clock signal CKref is set to 100 kHz or the divisor thereof. If the ½ frequency divider is further arranged at the post-stage of the frequency modulator 20, and the output signal S3 is ½-frequency-divided, and then, output to the block of post-stage, the reference clock CKref is set at 200 kHz or the divisor thereof. Moreover, the frequency fext of the external clock signal CKext is desirably set to integral multiples of the frequency f3 of the reference clock signal CKref(=CK3) of the PLL circuit.

According to the FM transmitter 100 configured as above, the first clock signal CK1 used for switching the switched capacitor filter of the filter circuit 50, the reference clock signal CK2 for generating the stereo composite signal S2, and the reference clock signal CK3(=CKref) of the PLL circuit are generated from the same external clock signal CKext using the programmable frequency dividers. That is, the first clock signal CK1, the reference clock signal CK2 and the reference clock signal CK3 are signals having the same origin. Consequently, a dedicated oscillator is not required to be arranged, and the circuit size can be reduced. The desired reference clock necessary in the filter circuit 50, the stereo modulator 10, and the frequency modulator 20 can be obtained even if the frequency of the external clock signal CKext differs for each set mounted with the FM transmitter, since the frequency dividing ratios n1, n2, n3 of the first programmable frequency divider 40, the second programmable frequency divider 42, and the third programmable frequency divider 44 can be set independently.

The reference clock signal CKref(=CK3) of the PLL circuit must be generated at high precision since it influences the frequency of the carrier wave of the FM transmitter 100, whereas the frequency precisions of the first clock signal CK1 used for switching the switched capacitor filter of the filter circuit 50 and the reference clock signal CK2 for generating the stereo composite signal are not required to be high. The performance of the entire FM transmitter can be improved by preferentially defining the relationship between the frequency of external clock signal CKext and the reference clock signal CKref(=CK3) of the PLL circuit over the relationship of the external clock CKext and the first clock signal CK1, the second clock signal CK2.

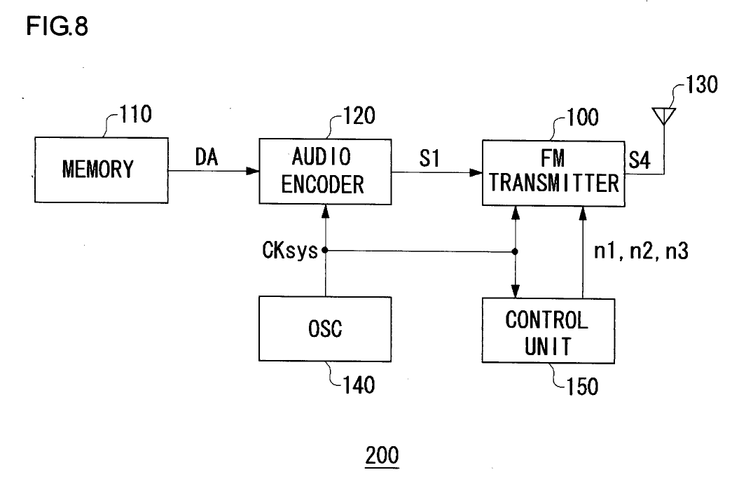

The configuration and the operation of the FM transmitter have been described above based on the embodiments. An application of the FM transmitter 100 according to the embodiment will now be described. The above described FM transmitter 100 is preferably mounted to compact electronic equipments such as portable terminal having audio reproducing function. FIG. 8 is a block diagram showing the configuration of the compact electronic equipment mounted with the FM transmitter of the embodiment.

The compact electronic equipment 200 includes the FM transmitter 100, a memory 110, an audio encoder 120, an antenna 130, an oscillator 140, and a control unit 150. The oscillator 140 has a predetermined oscillating frequency, and generates a system clock CKsys of the compact electronic equipment 200. The audio data is recorded in the memory 110 in a compressed or non-compressed form. The audio encoder 120 reads the audio data DA from the memory 110, encodes the same as necessary, generates and outputs the audio signals S1L, S1R to the FM transmitter 100. The FM transmitter 100 stereo-modulates and frequency-modulates, as described above, and outputs the amplified high frequency signal S4 to the antenna 130.

The audio encoder 120 and the control unit 150 perform a predetermined calculating process in response to the system clock signal CKsys. The system clock signal CKsys is input to the FM transmitter 100 as external clock signal CKext.

The control unit 150 is, for example, a microprocessor that sets the frequency dividing ratios n1, n2, n3 or the like of the first programmable frequency divider 40, the second programmable frequency divider 42, and the third programmable frequency divider 44 of the FM transmitter 100 according to the oscillation frequency of the oscillator 140, that is, the frequency of the system clock CKsys. The frequency dividing ratios are set by preparing a register or the like in the FM transmitter 100, and allowing the value to be externally changeable.

Miniaturization and reduction in cost of the compact electronic equipment 200 of FIG. 8 are possible since the filter circuit 50 of the FM transmitter 100 can be designed compact according to the present embodiment, as described above. The system clock CKsys is used as the external clock signal of the FM transmitter 100 and is used as clock signal of other circuit blocks, and thus can be operated with one oscillator. That is, miniaturization and reduction in cost of the set can be achieved since an expensive crystal transducer is not required to be arranged exclusive to the FM transmitter. Stable stereo modulation and frequency modulation can be realized by appropriately setting the frequency dividing ratios n1, n2 of the first programmable frequency divider 40 and the second programmable frequency divider 42 even when the FM transmitter 100 is mounted to sets in which the frequencies of the system clock signals differ. That is, the FM transmitter 100 is not limited by the system clock of the set to which it is mounted, and has an advantage of having high versatility compared to the conventional FM transmitter.

The embodiments are illustrative, and it should be recognized by those skilled in the art that various modifications in combination of each component and each processing process are possible, and such modifications should be recognized as being encompassed within the scope of the present invention.

The external clock signal CKext input to the clock input terminal 106 is frequency-divided to generate the first clock signal CK1 to third clock signal CK3, as shown in FIG. 1 in the embodiment, but the present invention is not limited thereto. Namely, the oscillator that oscillates at the frequency necessary in the filter circuit 50, the stereo modulator 10, and the frequency modulator 20 may be exclusively arranged. In this case, the frequency supplied to each block can be respectively optimized, and thus is advantageous in terms of performance of the device.

While the preferred embodiments of the present invention have been described using specific terms, such description is for illustrative purposes only, and it is to be understood that changes and variations may be made without departing from the spirit or scope of the appended claims.

What is claimed is:

1. An FM transmitter for converting an input audio signal to a stereo composite signal, and frequency-modulating the stereo composite signal and outputting the obtained signal, the FM transmitter comprising:
a filter circuit to which the input audio signal is input, and which corrects the band and outputs the band-corrected signal;
a stereo modulator which stereo-modulates the output signal of the filter circuit, and converts the signal to the stereo composite signal; and
a frequency modulator which frequency-modulates based on the stereo composite signal output from the stereo modulator; wherein
at least one part of the filter circuit is configured with a switched capacitor filter.

2. The FM transmitter according to claim 1, wherein
the filter circuit includes a low pass filter which removes high frequency component of the input audio signal, the low pass filter being configured with the switched capacitor filter.

3. The FM transmitter according to claim 1, wherein
the filter circuit includes a pre-emphasis circuit which emphasizes the high frequency component of the input audio signal, the pre-emphasis circuit being configured with the switched capacitor filter.

4. The FM transmitter according to claim 1, wherein
the filter circuit includes,
a pre-emphasis circuit which emphasizes high frequency component of the input audio signal,
a low pass filter which is arranged at a pre-stage or a post-stage of the pre-emphasis circuit, and removes the high frequency component of the input audio signal; and
the pre-emphasis circuit and the low pass filter are configured with the switched capacitor filter.

5. The FM transmitter according to claim 2, wherein
the frequency characteristic of the low pass filter configured with the switched capacitor filter has a notch at 19 kHz and 38 kHz.

6. The FM transmitter according to claim 2, wherein
the order of the low pass filter configured with the switched capacitor filter is greater than or equal to third order and less than or equal to seventh order.

7. The FM transmitter according to claim 6, wherein
the order of the low pass filter configured with the switched capacitor filter is fifth order, and the frequency characteristic has a notch at 19 kHz and 38 kHz.

8. The FM transmitter according to claim 3, wherein
the pre-emphasis circuit configured with the switched capacitor filter includes a variable capacitor, and the frequency to be emphasized is varied depending on the capacitance value of the variable capacitor.

9. The FM transmitter according to claim 1, wherein
the frequency of a clock signal used for switching the switched capacitor filter is set between 100 kHz and 1 MHz.

10. The FM transmitter according to claim 1, wherein
the frequency modulator is configured with a direct modulation type including a PLL (Phase Locked Loop) circuit; and
the clock signal used for switching the switched capacitor filter is a signal having the same origin as a reference clock signal of the PLL circuit of the frequency modulator.

11. The FM transmitter according to claim 1, wherein
the clock signal used for switching the switched capacitor filter may be a signal having the same origin as the sub-carrier wave of 38 kHz and the pilot signal of 19 kHz used in the stereo modulator.

12. The FM transmitter according to claim 1, further comprising a frequency divider which frequency-divides a system clock of a set on which the FM transmitter is mounted, and outputs the obtained signal as a clock signal used for switching the switched capacitor filter.

13. The FM transmitter according to claim 1, wherein
the stereo modulator, the frequency modulator and one part of the filter circuit configured with the switched capacitor filter are integrated on one semiconductor substrate.

14. A filter circuit arranged at a pre-stage of a frequency modulator which frequency-modulates an input audio signal; the filter circuit comprising:
a pre-emphasis circuit which emphasizes high frequency component of the input audio signal; and
a low pass filter which is arranged at a pre-stage or a post-stage of the pre-emphasis circuit, and removes the high frequency component of the input audio signal; wherein
at least one of the pre-emphasis circuit or the low pass filter is configured with a switched capacitor filter.

15. The filter circuit according to claim 14, wherein
the frequency modulator is configured with a direct modulation type including a PLL (Phase Locked Loop) circuit; and
a clock signal used for switching the switched capacitor filter is a signal having the same origin as a reference clock signal of the PLL circuit of the frequency modulator.

16. An electronic component comprising:
the FM transmitter according to claim 1;
an antenna which transmits an output signal of the FM transmitter to the outside;
an oscillator which generates a system clock of a predetermined frequency; and
a first frequency divider which frequency-divides the system clock at a first frequency dividing ratio, and supplies the obtained signal to the switched capacitor filter of the FM transmitter.

17. The electronic component according to claim 16, further comprising:
a second frequency divider which frequency-divides the system clock at a second frequency dividing ratio and supplies the obtained signal to a stereo modulator of the FM transmitter in order to generate a sub-carrier wave of 38 kHz and a pilot signal of 19 kHz; and
a third frequency divider which frequency-divides the system clock at a third frequency dividing ratio and supplies the obtained signal to the frequency modulator of the FM transmitter configured with a direct modulation type including a PLL (Phase Locked Loop) circuit as a reference clock signal of the PLL circuit.
